(19) United States
(12) Patent Application Publication
(10) Pub. No.: US 2015/0292890 A1
(43) Pub. Date: Oct. 15, 2015

(54) METHOD AND APPARATUS FOR DISPLAYING ROAD MAP

(71) Applicant: Tencent Technology (Shenzhen) Co., Ltd., Shenzhen (CN)

(72) Inventors: Shangyi SUN, Shenzhen (CN); Lina TIAN, Shenzhen (CN)

(21) Appl. No.: 14/750,546

(22) Filed: Jun. 25, 2015

Related U.S. Application Data
(63) Continuation of application No. PCT/CN2013/084271, filed on Sep. 26, 2013.

(30) Foreign Application Priority Data
Dec. 27, 2012 (CN) 201210578911.3

(51) Int. Cl. G01C 21/26; G06T 11/20; G06F 17/30

(52) U.S. Cl. CPC G01C 21/26; G06F 17/30241; G06T 11/203

(57) ABSTRACT

In embodiments of the present invention, road maps corresponding to different preset display scales are preset, where the different preset display scales correspond to different comprehensive correction maps, and the different comprehensive correction maps have different geographical identification information. After a map operation instruction is received, a road map in a corresponding preset display scale can be directly invoked, so as to display geographical identification information corresponding to the road map. The effect for displaying road map may be improved.

This application is a continuation of PCT/CN2013/084271, filed on Sep. 26, 2013 and entitled “METHOD AND APPARATUS FOR DISPLAYING ROAD MAP AND STORAGE MEDIUM”, which claims priority to Chinese Patent Application No. 201210578911.3, entitled “METHOD AND APPARATUS FOR DISPLAYING ROAD MAP AND STORAGE MEDIUM” filed on Dec. 27, 2012, both of which are incorporated herein by reference in their entirety.

### FIELD OF THE TECHNOLOGY

The present disclosure relates to the field of computer information processing, and in particular, to a method and an apparatus for displaying a road map, and a storage medium.

### BACKGROUND OF THE DISCLOSURE

With the continuous development of Internet technologies and the popularity of the application of computer information processing technologies, traditional traffic maps are gradually used for providing traffic map services on the Internet for Internet users.

In the existing technology, a traditional traffic map is used for providing traffic map service for an Internet user via FLASH display technology. However, a map file for which such a

FLASH display technology is used is generated based on an original traffic map by using the computer processing technology. When the Internet user uses the traffic map, the map file is zoomed in or out to allow the Internet user to view or use the traffic map in different scales. Traffic sites, that are displayed clearest when the traffic map is in the most original state, are unclear in the zoomed in or out traffic map for the user viewing the traffic map, in other words, the site information is not obvious for poor display effect.

As a result, the conventional traffic map display technology has a disadvantage of poor display effect for the traffic map.

### SUMMARY

An objective of the present disclosure is to provide a method and an apparatus for displaying a road map, and a storage medium, so as to improve the poor effect in displaying traffic map with conventional technology.

To solve the technical problem, the present disclosure provides a method for displaying a road map, including:

acquiring a road map;

generating, from the acquired road map, at least two comprehensive correction maps corresponding to the road map, one of the comprehensive correction maps corresponding to a preset display scale, and including geographical identification information corresponding to the preset display scale;

storing the at least two generated comprehensive correction maps;

receiving, when displaying the road map, a map operation instruction, the map operation instruction corresponding to the preset display scale;

acquiring the comprehensive correction map in the preset display scale corresponding to the map operation instruction, and then acquiring a corresponding road map; and

loading and displaying the acquired road map.

To solve the technical problem, the present disclosure further provides a method for displaying a road map, including:

receiving a map operation instruction, the map operation instruction corresponding to a preset display scale, a road map in the preset display scale corresponding to a comprehensive correction map, and the comprehensive correction map including geographical identification information corresponding to the preset display scale;

acquiring the comprehensive correction map in the preset display scale corresponding to the map operation instruction, and then acquiring a corresponding road map; and

loading and displaying the acquired road map.

To solve the technical problem, the present disclosure further provides an apparatus for displaying a road map, including:

one or more processors;

memory; and

a plurality of program modules stored in the memory and to be executed by the one or more processors, the plurality of program modules further including:

an operation instruction receiving module, configured to receive a map operation instruction, the map operation instruction corresponding to a preset display scale, a road map in the preset display scale corresponding to a comprehensive correction map, and the comprehensive correction map including geographical identification information corresponding to the preset display scale;

a first acquiring module, configured to acquire the comprehensive correction map in the preset display scale corresponding to the map operation instruction, and then acquire the corresponding road map; and

a display module, configured to load and display the acquired road map.

To solve the technical problem, the present disclosure further provides a storage medium, having processor-executable instructions stored therein, where the processor-executable instructions enable a processor to perform the following operations:

receiving a map operation instruction, the map operation instruction corresponding to a preset display scale, a road map in the preset display scale corresponding to a comprehensive correction map, and the comprehensive correction map including geographical identification information corresponding to the preset display scale;

acquiring the comprehensive correction map in the preset display scale corresponding to the map operation instruction, and then acquiring the corresponding road map; and

loading and displaying the acquired road map.

Compared with the existing technology, in embodiments of the present invention, road maps corresponding to different preset display scales are preset, where the different preset display scales correspond to different comprehensive correction maps, and the different comprehensive correction maps have different geographical identification information. Therefore, after a map operation instruction is received, a road map in a corresponding preset display scale can be directly invoked, so as to display geographical identification information corresponding to the road map. In the embodiments of the present invention, road maps in different preset display scales display different geographical identification information, so that display effect of the geographical identification information is correspondingly adjusted according to the preset display scales. For example, for a small scale, it is set to display less geographical identification information, to highlight site information, and improve display effect of the road map.

### BRIEF DESCRIPTION OF THE DRAWINGS

FIG. 1 is a schematic diagram of an operating environment of a method for displaying a road map according to an embodiment of the present invention;

FIG. 2 is a flowchart of a method for displaying a road map according to a preferred embodiment of the present invention;

FIG. 3A is a schematic structural diagram of an apparatus for displaying a road map according to a preferred embodiment of the present invention; and

FIG. 3B is a schematic structural diagram of modules in an apparatus for displaying a road map according to a preferred embodiment of the present invention.

### DESCRIPTION OF EMBODIMENTS

Referring to the drawings, same numerals represent same components. A principle of the present disclosure is described by using examples in which the present disclosure is implemented in proper computing environments. The following descriptions are specific embodiments of the present invention based on the examples, and should not be regarded as a limitation to other specific embodiments of the present invention that are not described herein in detail.

In the following descriptions, unless otherwise stated, the specific embodiments of the present invention will be described with reference to steps with reference numerals performed by one or more computers. Therefore, these steps and operations will be referred to as being performed by a computer. The expression of “being performed by a computer” herein includes an operation of a processing unit in the computer of electrical signals representing data in a structured form. This operation converts the data or maintains the data at a location in a memory system of the computer, which reconfigures or otherwise alters the operation of the computer in a manner well known by a person skilled in the art. A data structure in which data is maintained is a physical location of the memory, and has a specific feature defined by the format of the data. However, the principle of the present disclosure is described in the foregoing context, it is not meant to be limiting as a person skilled in the art will appreciate that multiple steps and operations described below may also be implemented in hardware.

The principle of the present disclosure is performed by using many other general-purpose or specific-purpose operations, communications environments, or configurations. A known example which is suitable for being applied to a calculation system, an environment, and a configuration of the present disclosure may include (but is not limited to) a handheld phone, a personal computer, a server, a multiprocessor system, a microcomputer dedicated system, a host architecture type computer, and a distributed calculation environment, which include any one of the foregoing systems or apparatuses.

The term “module” used herein may be regarded as a software object executed on the operating system. Different components, modules, engines and services described herein may be regarded as objects implemented in the calculation system. However, the apparatuses and methods described herein are preferably implemented in a form of software, and certainly, may also be implemented in hardware, both of which fall within the protection scope of the present disclosure.

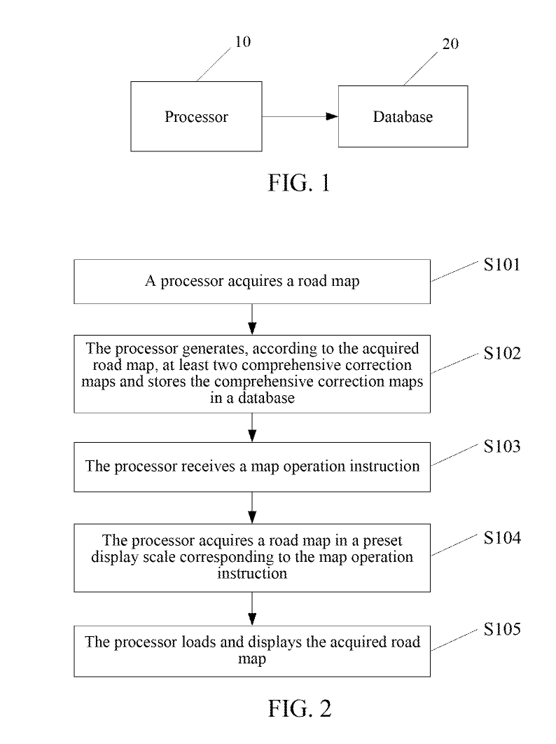

Referring to FIG. 1, FIG. 1 is a schematic diagram of an operating environment of a method for displaying a road map according to an embodiment of the present invention. The environment includes a processor 10 and a database 20. The database 20 stores road maps, and the processor 10 invokes, after receiving a map operation instruction of a user, a corresponding road map from the database 20 for displaying.

Referring to FIG. 2, FIG. 2 is a flowchart of a method for displaying a road map according to a preferred embodiment of the present invention.

S101: The processor 10 acquires the road map.

In this step, a road map to be used is received and stored in advance.

S102: The processor 10 generates, from the acquired road map, at least two comprehensive correction maps and stores the comprehensive correction maps in the database 20. For example, the comprehensive correction maps include a first comprehensive correction map and a second comprehensive correction map.

In practice, the received and stored road map is comprehensively corrected. Specifically, the road map is processed to generate at least two comprehensive correction maps, where each of the comprehensive correction maps corresponds to a different preset display scale, and each comprehensive correction map includes geographical identification information corresponding to the comprehensive correction map. The number of sites in the road map that are identified in the first comprehensive correction map is different from that of sites in the road map that are identified in the second comprehensive correction map. For example, if the preset display scale corresponding to the first comprehensive correction map is larger than the preset display scale corresponding to the second comprehensive correction map, the number of the sites in the road map that are identified in the first comprehensive correction map is greater than that of the sites in the road map that are identified in the second comprehensive correction map. Certainly, it may also be set that character sizes or picture sizes of the identified sites are different, and the like, which is not specifically limited.

S103: The processor 10 receives a map operation instruction.

In this step, the map operation instruction corresponds to the road map in the preset display scale. For example, the preset display scale includes a first preset display scale and a second preset display scale. In the first preset display scale, the road map corresponds to the first comprehensive correction map; and in the second preset display scale, the road map corresponds to the second comprehensive correction map. In addition, the first comprehensive correction map has first geographical identification information, and the second comprehensive correction map has second geographical identification information.

Specifically, in this embodiment of the present invention, at least two preset display scales are set, and one comprehensive correction map is set corresponding to each of the preset display scales. Different preset display scales correspond to different comprehensive correction maps. For example, the first comprehensive correction map is set corresponding to the first preset display scale, and the second comprehensive correction map is set corresponding to the second preset display scale. In addition, the first comprehensive correction map has the first geographical identification information, and the second comprehensive correction map has the second geographical identification information. For example, if the first geographical identification information and the second geographical identification information are used to identify sites in the road map, the number of sites identified in the first geographical identification information is different from that of sites identified in the second geographical identification information.

Further, when the first preset display scale is greater than the second preset display scale, in this embodiment of the present invention, the number of the sites identified in the first geographical identification information is set to be greater than the number of the sites identified in the second geographical identification information, in other words, the number of sites identified in the road map in a larger preset display scale is less than the number of sites identified in the road map in a smaller preset display scale.

S104: The processor 10 acquires the road map in the preset display scale corresponding to the map operation instruction.

In this step, upon receiving the map operation instruction, the processor 10 acquires a corresponding road map according to the preset display scale corresponding to the map operation instruction.

Specifically, when the map operation instruction that is used for displaying in the first preset display scale is received, the first comprehensive correction map is loaded and displayed; and when the map operation instruction that is used for displaying in the second preset display scale is received, the second comprehensive correction map is loaded and displayed. Certainly, more preset display scales may also be set, and more comprehensive correction maps may be set corresponding to the different preset display scales. Different comprehensive correction maps correspond to different geographical identification information, in other words, different comprehensive correction maps identify different number of sites for the road map.

Further, each of the preset display scales corresponds to one road map, and the road map corresponds to one comprehensive correction map in turn, where the comprehensive correction map includes a preset number of comprehensive correction map blocks. For example, in the first preset display scale, the road map includes the first comprehensive correction map, and the first comprehensive correction map includes a first preset number of the comprehensive correction map blocks; and in the second preset display scale, the road map includes the second comprehensive correction map, and the second comprehensive correction map includes a second preset number of the comprehensive correction map blocks. The first preset number and the second preset number are set to be different, and certainly, in some cases, may be the same. In a specific embodiment, if the first preset display scale is larger than the second preset display scale, the first preset number is set to be greater than the second preset number.

S105: The processor 10 loads and displays the acquired road map.

This step is used to display the acquired road map in the preset display scale corresponding to the map operation instruction. Specifically, this step includes the following.

First, the preset display scale corresponding to the map operation instruction is acquired. For example, when a user needs to use the road map in the first preset display scale, the user inputs a map operation instruction corresponding to the first preset display scale by clicking or dragging a button corresponding to the first preset display scale, Certainly the user may perform another operation, and the operation described herein is only used as an example and is not meant to limit the disclosure. When the map operation instruction is received, a demand of the user for using the preset display scale of the road map is acquired.

Subsequently, the road map corresponding to the preset display scale is loaded and displayed according to the preset display scale.

Further, when the road map includes the comprehensive correction map blocks, the comprehensive correction map blocks corresponding to the preset display scale are loaded and displayed according to the preset display scale, until the road map is completely displayed. Certainly, when the comprehensive correction map blocks are loaded and displayed, a loading sequence may be preset for the comprehensive correction map blocks. For example, it may be set that a comprehensive correction map block at a position clicked by the user is loaded preferentially, and then a comprehensive correction map block far away from the position clicked by the user is loaded. In this step, the road map is separated into multiple regions of the comprehensive correction map for loading and displaying, so that display effect and display efficiency of the road map are improved.

In this embodiment of the present invention, road maps corresponding to different preset display scales are preset, where the different preset display scales correspond to different comprehensive correction maps, and the different comprehensive correction maps have different geographical identification information. Therefore, after a map operation instruction is received, a road map in a corresponding preset display scale can be directly invoked, so as to display geographical identification information corresponding to the road map. In this embodiment of the present invention, road maps in different preset display scales display different geographical identification information, so that display effect of the geographical identification information is correspondingly adjusted according to the preset display scales. For example, for a small scale, it is set to display less geographical identification information, to highlight site information, and improve effect for displaying road map.

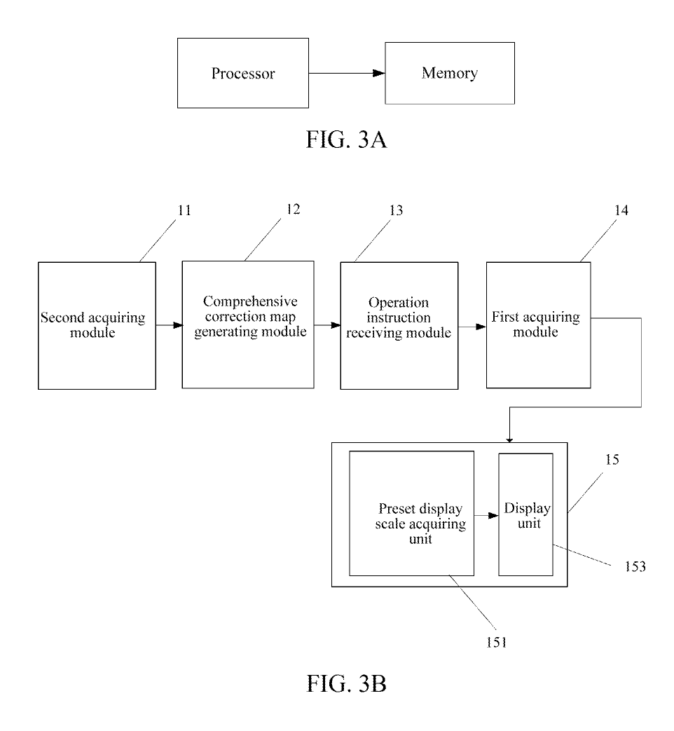

Referring to FIG. 3A and FIG. 3B, schematic structural diagrams of an apparatus for displaying a road map according to a preferred embodiment of the present invention are shown.

As shown in FIG. 3A, the apparatus for displaying a road map in this embodiment of the present invention includes: one or more processors; memory; and a plurality of program modules stored in the memory and to be executed by the one or more processors. As shown in FIG. 3B, the plurality of program modules include a second acquiring module 11, a comprehensive correction map generating module 12, an operation instruction receiving module 13, a first acquiring module 14, and a display module 15.

The second acquiring module 11 is configured to acquire the road map, and the comprehensive correction map generating module 12 is configured to generate at least one comprehensive correction map from the acquired road map. For example, the comprehensive correction map generates a first comprehensive correction map and a second comprehensive correction map.

The operation instruction receiving module 13 is configured to receive a map operation instruction, where the map operation instruction corresponds to a preset display scale, a road map in the preset display scale corresponds to a comprehensive correction map, and the comprehensive correction map includes geographical identification information corresponding to the preset display scale.

For example, the preset display scale includes a first preset display scale and a second preset display scale, the road map has a first comprehensive correction map corresponding to the first preset display scale, and has a second comprehensive correction map corresponding to the second preset display scale. In addition, the first comprehensive correction map has first geographical identification information, and the second comprehensive correction map has second geographical identification information. The road map corresponding to each preset display scale includes a preset number of comprehensive correction map blocks. For example, the first comprehensive correction map includes a first number of the comprehensive correction map blocks, and the second comprehensive correction map includes a second number of the comprehensive amendment map blocks.

The first acquiring module 14 is configured to acquire the road map in the preset display scale corresponding to the acquired map operation instruction.

The display module 15 is configured to load and display the acquired road map. The display module includes a preset display scale acquiring unit 151 and a display unit 153. The preset display scale acquiring unit 151 is configured to acquire the preset display scale corresponding to the map operation instruction. The display unit 153 is configured to load and display, according to the preset display scale, the comprehensive correction map blocks corresponding to the preset display scale, until the road map is completely displayed.

Certainly, when the display unit 153 loads and displays the comprehensive correction map blocks, a loading sequence may be preset for the comprehensive correction map blocks. For example, it may be set that a comprehensive correction map block at a position clicked by the user is loaded preferentially, and then a comprehensive correction map block far away from the position clicked by the user is loaded. As the road map is separated into multiple regions of comprehensive correction map for loading and displaying, a display effect and display efficiency of the road map are improved.

In this embodiment of the present invention, road maps corresponding to different preset display scales are preset, where the different preset display scales correspond to different comprehensive correction maps, and the different comprehensive correction maps have different geographical identification information. Therefore, after a map operation instruction is received, a road map in a corresponding preset display scale can be directly invoked, so as to display geographical identification information corresponding to the road map. In this embodiment of the present invention, road maps in different preset display scales display different geographical identification information, so that a display effect of geographical identification information is correspondingly adjusted according to the preset display scales. For example, for a small scale, it is set to display less geographical identification information, to highlight site information, and improve effect for displaying road map.

The apparatus for displaying a road map provided in this embodiment of the present invention is formed in a terminal. The terminal may be a desktop computer, or may be a terminal machine that has a calculation capability and a storage unit and has a microprocessor installed, such as a notebook computer, a workstation, a handheld computer, an ultra mobile personal computer (UMPC), a tablet PC, a personal digital assistant (PDA), a web pad, or a portable telephone. The apparatus for displaying a road map and the method for displaying a road map in the foregoing embodiment are based on the same conception, and any method provided in the embodiment of the method for displaying a road map may be operated on the apparatus for displaying a road map. For the specific implementation process, one may refer to the embodiment of the method for displaying a road map for details, and details are not described herein again.

It should be noted that, for the method for displaying a road map in the embodiments of the present invention, a person of ordinary skill in the art can understand that the whole or part of a process of the method for displaying a road map in the embodiments of the present invention may be implemented by a computer program instructing relevant hardware. The computer program may be stored in a computer-readable storage medium, such as a memory of a terminal, and executed by at least one processor in the terminal. The implementation procedure may include the foregoing processes of the embodiments of the methods. The storage medium may be a magnetic disk, an optical disc, a read-only memory (ROM), a random access memory (RAM), or the like.

For the apparatus for displaying a road map in the embodiments of the present invention, the functional modules thereof may be integrated into one processing chip, or each module may exist separately and physically, or two or more modules may be integrated into one module. The foregoing integrated module may be implemented in a form of hardware, or may be implemented in a form of a software functional module. When the integrated module is implemented in the form of the software functional module and sold or used as an individual product, it may also be stored in a computer-readable storage medium. The storage medium is, for example, a read-only memory, a magnetic disk, or an optical disc.

To sum up, the present disclosure has been disclosed through preferred embodiments;

however, the preferred embodiments are not intended to limit the present disclosure. A person of ordinary skill in the art can make various modifications or improvements without departing from the spirit and scope of the present disclosure. Therefore, the protection scope of the present disclosure should be subject to the scope defined by the claims.

What is claimed is:

1. A method for displaying a road map, comprising an apparatus which comprises a processor coupled to a memory storing executable instruction codes, a communication interface and a display, the method comprising the apparatus performing:
acquiring a road map from a database;
generating, from the acquired road map, at least two comprehensive correction maps corresponding to the road map, one of the comprehensive correction maps corresponding to a preset display scale and comprising geographical identification information corresponding to the preset display scale;
storing the at least two generated comprehensive correction maps;
receiving, when displaying the road map, a map operation instruction, the map operation instruction corresponding to the preset display scale;
acquiring the comprehensive correction map in the preset display scale corresponding to the map operation instruction, and then acquiring a corresponding road map; and
loading and displaying the acquired road map on the display.

2. The method for displaying a road map according to claim 1, wherein the comprehensive correction map in the preset display scale corresponds to a preset number of comprehensive correction map blocks.

3. The method for displaying a road map according to claim 2, wherein the step of loading and displaying the acquired road map on the display, comprises:
acquiring the preset display scale corresponding to the map operation instruction; and
loading and displaying, according to the preset display scale, the comprehensive correction map blocks corresponding to the preset display scale, so as to display the corresponding road map on the display.

4. A method for displaying a road map, comprising an apparatus which comprises a processor coupled to a memory storing executable instruction codes, a communication interface and a display, the method comprising the apparatus performing:
receiving a map operation instruction, the map operation instruction corresponding to a preset display scale, a road map in the preset display scale corresponding to a comprehensive correction map, and the comprehensive correction map comprising geographical identification information corresponding to the preset display scale;
acquiring the comprehensive correction map in the preset display scale corresponding to the map operation instruction, and then acquiring a corresponding road map; and
loading and displaying the acquired road map on the display.

5. The method for displaying a road map according to claim 4, further comprising:
acquiring the road map from a database in advance before the map operation instruction is received; and
generating, from the acquired road map, at least two comprehensive correction maps corresponding to the road map, wherein one of the comprehensive correction maps corresponds to the preset display scale on the display.

6. The method for displaying a road map according to claim 5, wherein the comprehensive correction map in the preset display scale corresponds to a preset number of comprehensive correction map blocks.

7. The method for displaying a road map according to claim 6, wherein the step of loading and displaying the acquired road map on the display, comprises:
acquiring the preset display scale corresponding to the map operation instruction; and
loading and displaying, according to the preset display scale, the comprehensive correction map blocks corresponding to the preset display scale, so as to display the corresponding road map on the display.

8. An apparatus for displaying a road map, comprising:
one or more processors;
a memory coupled to the one or more processors; and
a plurality of program modules with instruction codes stored in the memory to be executed by the one or more processors, the instruction codes stored when executed by the one or more processors, configure the apparatus to:
receive a map operation instruction, the map operation instruction corresponding to a preset display scale, a road map in the preset display scale corresponding to a comprehensive correction map, and the comprehensive correction map comprising geographical identification information corresponding to the preset display scale;
acquire the road map from a database in the preset display scale corresponding to the map operation instruction; and
load and display the acquired road map on a display.

9. The apparatus for displaying a road map according to claim 8, wherein the apparatus is further configured to:
acquire the road map in advance before the map operation instruction is received; and
generate, from the acquired road map, at least two comprehensive correction maps corresponding to the acquired road map, wherein one of the comprehensive correction maps corresponds to the preset display scale.

10. The apparatus for displaying a road map according to claim 9, wherein the comprehensive correction map in the preset display scale corresponds to a preset number of comprehensive correction map blocks.

11. The apparatus for displaying a road map according to claim 10, wherein the apparatus is further configured to:
acquire the preset display scale corresponding to the map operation instruction; and
load and display, according to the preset display scale, the comprehensive correction map blocks corresponding to the preset display scale, so as to display the corresponding road map.
